(19) United States
(12) Patent Application Publication
(10) Pub. No.: US 2026/0064479 A1
(43) Pub. Date: Mar. 5, 2026

(54) SELF-TUNING, HYPERSCALING, MULTI-CLASS PROCESSOR ARCHITECTURE FOR EFFICIENT HIGH-PERFORMANCE COMPUTE WORKLOADS

(71) Applicant: Cloud Computing Solutions Group, Inc. DBA I/ONX HPC, Henderson, NV (US)

(72) Inventors: Justyn Hornor, Henderson, NV (US); Patrick Gilmartin, Henderson, NV (US)

(21) Appl. No.: 19/317,913

(22) Filed: Sep. 3, 2025

Related U.S. Application Data
(60) Provisional application No. 63/690,465, filed on Sep. 4, 2024.

(51) Int. Cl. G06F 9/50

(52) U.S. Cl. CPC G06F 9/5044; G06F 9/505; G06F 9/5061; G06F 2209/508

(57) ABSTRACT

A node which comprises all necessary processors to operate a given application, said node comprising, for example, a power supply, a motherboard, a CPU, RAM, FPGA, RISC-V, GPU, networking (such as Ethernet, PCIe, SFP (optical), etc.), and solid-state storage. This node includes software that enables the processors and other components to effectively communicate during any given workload being run. Also disclosed is a system which comprises a single printed circuit board (PCB), a plurality of processors mounted on said PCB, wherein the plurality of processors includes at least four distinct types, differentiated by architecture or processing capabilities; a shared random access memory (RAM) accessible by each of the processors mounted on the PCB; wherein the system includes a management unit configured to dynamically assign tasks to one or more of the processors based on an evaluation of task requirements and processor capabilities, thereby enhancing processing efficiency and speed.

### STATEMENT OF CORRESPONDING APPLICATIONS

This application claims priority to U.S. Application No. 63/690,465 having a filing date of Sep. 4, 2024. The disclosure of the foregoing are hereby incorporated by reference.

### BACKGROUND

The present invention generally relates to processor architectures, and more specifically relates to a self-tuning, hyperscaling, multi-class processor architecture for efficient high-performance compute workloads.

Most current, high-performance computer platforms comprise a single, specific processor class as well as a particular chipset. To this end, processor manufacturers generally focus on a single processor type and supporting software, supporting software that typically only supports direct integrations of that particular processor type. This results in efficiency, speed, etc. not being optimized.

### SUMMARY

An object of an embodiment of the present invention is to provide a self-tuning, hyperscaling, multi-class processor architecture for efficient high-performance compute workloads.

Briefly, an embodiment of the present invention provides a node which comprises all necessary processors to operate a given application, said node comprising, for example, a power supply, a motherboard, a CPU, RAM, FPGA, RISC-V, GPU, networking (such as Ethernet, PCIe, SFP (optical), etc.), and solid state storage. This node includes software that enables the processors and other components to effectively communicate during any given workload being run.

Another embodiment of the present invention provides a system which comprises a single printed circuit board (PCB), a plurality of processors mounted on said PCB, wherein the plurality of processors includes at least four distinct types, differentiated by architecture or processing capabilities; a shared random access memory (RAM) accessible by each of the processors mounted on the PCB; wherein the system includes a management unit configured to dynamically assign tasks to one or more of the processors based on an evaluation of task requirements and processor capabilities, thereby enhancing processing efficiency and speed.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a black diagram showing the components of a node, where the node is accordance with an embodiment of the present invention; and

FIG. 2 is a black diagram showing the components of a Printed Circuit Board (PCB), where the PCB is accordance with an embodiment of the present invention.

### DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention and is not intended to limit the invention to that as illustrated.

Several acronyms known in the industry are used herein. These acronyms include, for example, PCB, CPU, RAM, FPGA, RISC-V, GPU, PCIe, SFP, ASIC, TPU, DPU, VPU. Those acronyms are explained below:

A PCB (Printed Circuit Board) is a board used in electronics to mechanically support and electrically connect electronic components using conductive pathways, tracks, or signal traces etched from copper sheets laminated onto a non-conductive substrate. PCBs are fundamental components in nearly all electronic devices.

A CPU (Central Processing Unit) is the primary component of a computer responsible for executing instructions and performing calculations. Often referred to as the “brain” of the computer, the CPU carries out basic arithmetic, logic, control, and input/output operations specified by the instructions in the computer's programs.

RAM (Random Access Memory) is a type of computer memory that is used to store data and machine code currently being used. It is called “random access” because any byte of memory can be accessed directly if you know the row and column that intersect at that byte. RAM is volatile memory, meaning it requires power to maintain the stored information. Once the computer is turned off, all data in RAM is lost.

An FPGA (Field-Programmable Gate Array) is an integrated circuit designed to be configured by the customer or designer after manufacturing-hence “field-programmable.” FPGAs are made up of a matrix of configurable logic blocks (CLBs) connected via programmable interconnects. They can be reprogrammed to desired application or functionality requirements after manufacturing, making them versatile for a variety of applications. FPGAs can be reprogrammed to perform different tasks, which allows for flexibility and updates even after the hardware has been deployed. FPGAs can also execute multiple operations in parallel, making them highly efficient for tasks that can be parallelized, such as signal processing and image processing.

RISC-V (pronounced “risk-five”) is an open-standard instruction set architecture (ISA) based on reduced instruction set computer (RISC) principles. Unlike proprietary ISAs like those from Intel and ARM, RISC-V is free to use and extend, which has led to widespread adoption in academia, research, and industry. The RISC-V ISA is freely available under open licenses, which promotes transparency, collaboration, and innovation. The base RISC-V ISA is simple, providing a solid foundation that can be extended with optional standard or custom extensions, making it highly modular and adaptable. RISC-V can be used for a wide range of applications, from small microcontrollers to powerful supercomputers, due to its flexible and scalable design.

A GPU (Graphics Processing Unit) is a specialized electronic circuit designed to accelerate the processing of images and videos. GPUs are highly efficient at performing the mathematical computations required for rendering graphics, which involves manipulating and displaying images on a screen. While initially developed for rendering graphics in video games and other visual applications, GPUs have evolved to handle a wide range of parallel computing tasks, including machine learning, scientific simulations, and data analysis.

PCIe (Peripheral Component Interconnect Express) is a high-speed interface standard used to connect various hardware components to a computer's motherboard. It is commonly used for connecting graphics cards, SSDs (solid-state drives), network cards, and other expansion cards. PCIe is known for its high data transfer rates, scalability, and flexibility.

SFP (Small Form-factor Pluggable) is a compact, hot-swappable network interface module used for both telecommunication and data communications applications. It enables a flexible, cost-effective way to connect networking equipment like switches, routers, and network interface cards to various types of fiber optic or copper networking cables.

An ASIC (Application-Specific Integrated Circuit) is a type of integrated circuit designed for a specific application or task, as opposed to general-purpose integrated circuits like CPUs or FPGAs. ASICs are custom-designed to perform a particular function or set of functions efficiently, which makes them highly optimized for that application but less flexible compared to programmable devices.

A TPU (Tensor Processing Unit) is a type of specialized hardware accelerator designed by Google specifically to accelerate machine learning and artificial intelligence (AI) tasks, particularly those involving tensor computations. TPUs are optimized for the types of matrix operations commonly used in deep learning models, making them highly efficient for training and inference of neural networks.

A DPU (Data Processing Unit) is a specialized hardware component designed to handle data-centric tasks efficiently, often focusing on accelerating data processing and networking functions. While the specific features and functions of DPUs can vary based on the manufacturer and application, they generally aim to offload and accelerate tasks that would otherwise be handled by the CPU, improving overall system performance and efficiency.

A VPU (Vision Processing Unit) is a specialized type of processor designed specifically to handle and accelerate computer vision tasks. VPUs are optimized for processing image and video data, making them essential in applications that require real-time visual data analysis and processing.

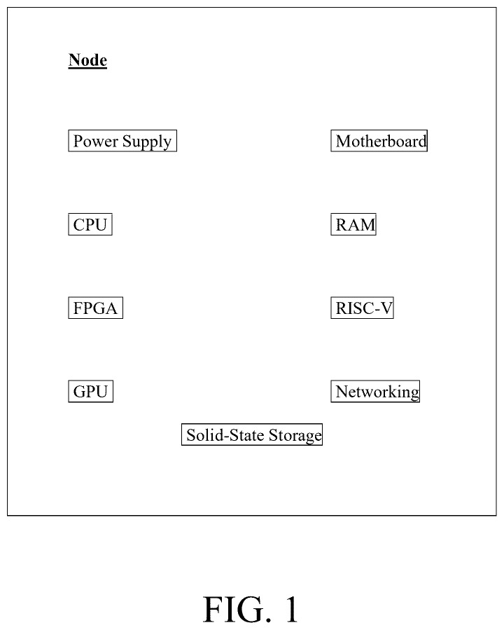

FIG. 1 is a black diagram showing the components of a node, where the node is accordance with an embodiment of the present invention. As shown, the node comprises all necessary processors to operate a given application. FIG. 1 shows a specific example wherein the node comprises, for example, a power supply, a motherboard, a CPU, RAM, FPGA, RISC-V, GPU, networking (such as Ethernet, PCIe, SFP (optical), etc.) and solid state storage. This node includes structure and software that enables the processors and other components to effectively communicate during any given workload being run.

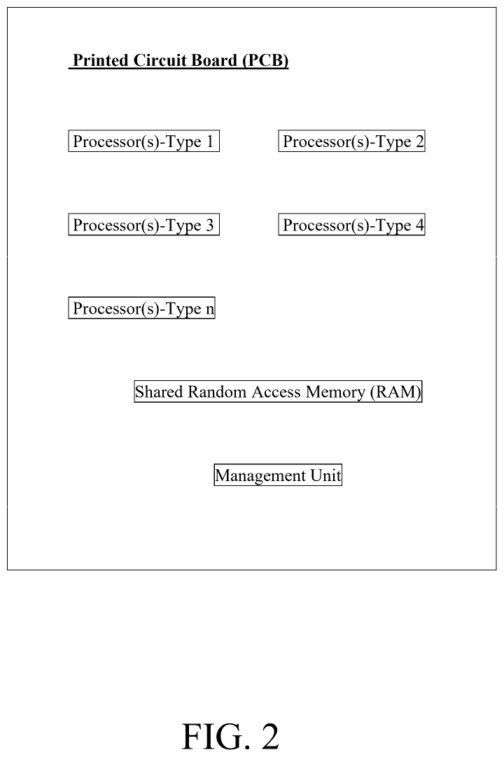

FIG. 2 black diagram showing the components of a system, wherein the system comprises a single printed circuit board (PCB) is accordance with an embodiment of the present invention. As shown, the single printed circuit board (PCB) comprises a plurality of processors mounted thereon, wherein the plurality of processors includes at least four distinct types (wherein “Processor(s)—Type n” represents possible additional types of processors), differentiated by architecture or processing capabilities, and a shared random access memory (RAM) accessible by each of the processors mounted on the PCB. The system includes a management unit configured to dynamically assign tasks to one or more of the processors based on an evaluation of task requirements and processor capabilities, thereby enhancing processing efficiency and speed.

An embodiment of the present invention radically improves high-performance computing common in artificial intelligence and other heavy workloads. At the simplest level, an embodiment of the present invention comprises an architecture of various processor classes with algorithms optimized to take advantage of each class of processor along with methods for hyperscaling the architecture.

An embodiment of the present invention provides a flexible, self-tuning hardware platform with multiple classes of processors that can scale from a single node to millions or more. Regarding the word “node”, it is used to refer to the smallest unit of processing which includes all the necessary processors to operate a given application. The processors and other equipment on the node are malleable to enable customized groupings of processors which results in the overall system being able to leverage one or many nodes—with different nodes having different classes of processors and other supporting equipment—RAM, networking, power supplies, solid state storage, etc.

A common, modern design pattern is that of an “agent/worker” architecture. The “agent/worker” architecture, also known as the “master/worker” or “controller/worker” architecture, is a design pattern commonly used in distributed computing and parallel processing systems. This architecture involves a central component (the agent, master, or controller) that distributes tasks to multiple subordinate components (the workers), which then perform the tasks and report back their results. This model is highly scalable and efficient for handling large volumes of work by distributing the load across multiple workers.

The agent and worker are contextual. For example, in the context of a node as described herein, the agent is a software application that communicates with the node to load the necessary software applications and data for a workload. The software running separately from the node is the agent and the node is the worker. However, the context changes within the node where each processor may act as the worker and a software layer on the node acts as the agent. This is important for understanding scalability.

Generally speaking, various processors are better suited for different algorithms and most high-performance workloads can be optimized for efficiency if a given application has access to the right processor for the right algorithm. An embodiment of the present invention generally comprises a platform that has the ideal mix of processor types such that any heavy workload can be operated optimally.

An embodiment of the present invention is ideal for use with Artificial Intelligence applications. To that end, Training versus Serving will now be discussed.

All Artificial Intelligence products have two primary stages: training and serving. An embodiment of the present invention supports modern training and serving techniques but is directed at improving the way the algorithms are operated on the hardware.

Regarding training, in the training stage a system is accordance with an embodiment of the present invention is especially critical as this process requires immense computing power. The process of training typically starts with a “blank” model file represented in the neural network as dense layers. As data is fed into the neural network during training, several additional heavy computational processes are required to update this model file to support learning and improving. This process repeats anywhere from a few dozen to millions of times until the model reaches a degree of accuracy that meets the customer's needs.

Additional types of training include transferred learning and model pruning, to name a few. Transferred learning is the process of loading a pre-trained model (rather than a “blank” model) and then running new data through the neural network such that the new model contains the learning from the original model and the new information. Pruning is a process whereby a pre-existing model has one of several methodologies applied to reduce the model file size while retaining as much of the accuracy as possible. Model serving is a subset of training as the predictions are used to validate whether the changes to the model file from the previous pass had been improved upon.

Regarding serving, once a model has been trained, the model can be loaded into a separate application on hardware that is structured in accordance with the present invention—referred to as serving the model. This application takes as input data similar to what the model was trained on and makes predictions about this new data. Generally speaking, the more sophisticated the training, the more efficient the model will be when it comes to serving it. This means that training a model requires more and more compute—and new algorithms are emerging that further exacerbate this challenge.

To highlight the importance and value of a system that is in accordance with an embodiment of the present invention, many new algorithms are emerging to improve how neural networks are trained and served. Many of the algorithms are not suited for GPUs, and ASIC-based processor designs may not have the required primitive functionality in their instruction sets to enable these novel algorithms to operate efficiently. A system that is in accordance with an embodiment of the present invention comprises various processor classes that can be updated to handle these algorithms with no action needed by the end-user. Further, as more efficient methodologies are developed, in most cases these can be delivered to the end-user via software updates. For the rare case where hardware upgrades would be required, the system enables quickly replacing or adding new processors to a node without a complete replacement of the entire node.

One of the main distinguishable characteristics of a system which is in accordance with an embodiment of the present invention is the implementation of many different classes of processors and even a mixture of subclasses.

The classes of processors could include, but are not limited to: Central Processing Units (CPU): for operating systems, process and data routing, software installation to other processors in a node, node utilization management, and other generalized use cases.

Graphics Processing Units (GPU): for data preprocessing and processing, algorithms that are ideal for parallel processing.

Field Programmable Gate Arrays (FPGA): for customized algorithms not supported by other processor types, load balancing, parallel processing.

Application Specific Integrated Chips (ASIC): for common algorithms where serialized processes are required, load balancing.
RISC-V
TPU (Tensor Processing Units)
DPU (Data Processing Units)
VPU (Video Processing Units)

Or any class of processor with an instruction set physically fabricated on the chip such as a matrix multiplier, such as:
Quantum: for complex algorithms where many permutations are needed, or extremely large datasets are required.
Memory: for load balancing, datastore-level algorithms.
Organoid: for low power algorithmic applications, load balancing

These are just a few of the current-state and near-term processor classes that a system in accordance with an embodiment of the present invention can use at a node level. Preferably, the system is processor agnostic such that when a new processor class emerges, it can be easily incorporated into the system.

Importantly, each class of processor can also include different capabilities within that processor class. For example, a node in accordance with an embodiment of the present invention may include four different FPGAs that each have unique properties. The first may include more silicon fabric while another may include more input/output capabilities, while another may include additional processors embedded in the system-on-module, while still another may operate at extremely low wattage relative to the others.

Another embodiment provides that multiple CPUs are on a node to manage node memory, data routing, application installation, encryption, and other distinct processes—a load balancing strategy. Preferably, the secondary CPU is considerably smaller, lower wattage, and has a slower processing speed, but has a considerable impact on the node's efficiency as the node can offload common processes that can interrupt the primary application's functions.

Still another example is the application of ASICs. There are many classes of ASICs, and many processors include embedded ASICs. In one specific embodiment of the present invention, a node is augmented with additional ASICs—such as RISC-V processors and TPUs—to handle algorithms that these processors operate exceedingly well.

A node in accordance with an embodiment of the present invention can be updated with different processors. The hardware and software design enables swapping out different processors such that any given node can be tailored to the application. Software ensures compatibility as new or different processors are incorporated into a given node.

Self-tuning (in the context of the present invention) is the ability for a system to adapt to a given workload and optimize the performance. Having multiple classes of processors enables an extreme degree of flexibility while an application is running on the system.

Self-tuning has several degrees:
1. Updating data being fed to the processors with sparse data and Bayesian filtering techniques, which may be done by the CPU, GPU, or other processors, to reduce the amount of math required for the processors to compute. The trade-off can be that the final product may have lower precision.
2. Utilizing any given processor available on the node or on other nodes for load balancing.
3. Updating parameters in the application to improve the learning rate, thereby reducing how long the application needs to be operated.
4. Reallocating algorithms to processors that can handle the calculations more efficiently—efficiency can be defined by the end user as less power consumption (in Wattage) or less time required to train a model.

As discussed above, most processor manufacturers focus on one specific processor type and supporting software typically only supports direct integrations. For example, Nvidia Corporation focuses on GPUs, and CUDA is the software framework for leveraging their processors. With a single-processor architecture, there is far less tuning that can be done—both prior to training a new model or during the process of training.

In contrast, with a system that is in accordance with an embodiment of the present invention, the system has many different classes and types of processors with which to tune the algorithm in real time. To make the point clearer, common GPUs by Nvidia, A M D, and Intel, which typically run at ˜450 Watts, while a RISC-V processor by Tenstorrent, PolarFire, or SiFive operates around 75 Watts. These two processors do very different things with varying degrees of efficiency, but both are common in high-performance compute environments. A system in accordance with an embodiment of the present invention may have both of these two processors (among others) on a single node and can tune the application in real time to leverage the benefits of both processors.

To expand this even further, a given training application may be able to be completed in one hour on a common GPU or four hours on a RISC-V. The GPU would require 900 Watts and the RISC-V processor 600 Watts respectively. A system which is in accordance with an embodiment of the present invention is configured to leverage both processors at the same time, load balancing and tuning the application in real-time, and complete the same training in, theoretically, 45 minutes using 400 Watts total.

A system which is in accordance with an embodiment of the present invention enables self-tuning for one of several user-selected outcomes (or “Runtime Plans”):
1. Speed—the system tunes the application and leverages processors to their full capacity to complete the training as quickly as possible—which can include automatically overclocking various aspects of the processors, RAM, power supply, and other systems.
2. Power consumption—the system optimizes on processors that are lower wattage, but at the expense of speed. This can be especially important in environments where power supply is highly variable, such as a data center that uses solar power during the day.
3. Accuracy—the system reduces the amount of sparsity and Bayesian filtering applied to the data to improve the accuracy of the trained model at the expense of power consumption and speed.
4. Balanced—this is preferably the default mode, whereby the system self-tunes to effectively balance speed, power consumption, and accuracy.

While a node in accordance with an embodiment of the present invention can include many different classes and types of processors, one specific embodiment comprises a power supply, motherboard, CPU, RAM, FPGA, RISC-V, GPU and Networking structure, such as Ethernet, PCIe, SFP (optical), solid state drives, etc. Regardless, the node preferably comprises software that enables the processors and other components to effectively communicate during any given workload being run.

In the case of FPGA, an embodiment of the present invention provides a node that comprises a carrier board that is configured to host 1-16 FPGAs and be easily expandable to host many more on the single carrier board. Preferably, the carrier board is connected to the node via PCIe, SFP, or other protocols as needed. The carrier board is preferably configured to host a uniform distribution of the same FPGA or each FPGA can be a different class with different capabilities. This flexibility allows for upgrading, servicing damaged parts, or modifying the FPGA class of processors in a given node to suit the needs of the workloads being operated.

While a node in accordance with an embodiment of the present invention could use a conventional motherboard, another embodiment of the present invention employs a printed circuit board (PCB) design that is specifically configured to host multiple classes of processors, thereby eliminating the overhead and complexity required of a standard motherboard. These nodes can create additional flexibility in the form factor. For example, in a standard rack found in a data center, instead of a node being consolidated into a smaller form factor, the FPGAs may be consolidated for all the nodes into a specific area in the rack that can improve physical space utilization while improving power supply access and cooling requirements. In this example, the node is still a single unit of compute, but its respective processors are physically separated relative to the typical design.

This type of modularity has many advantages, such as improved serviceability and upgradeability, and it enables optimization of the physical environment. Another less obvious benefit is that a multi-node network can load balance across the processors more efficiently as a given application will have more direct access to under-utilized processors.

An embodiment of the present invention comprises a multiple node network, wherein a node is scalable nearly infinitely with the only constraints being the ability to network nodes together.

A common architecture pattern is for multiple nodes to be housed in a rack in a data center. Then, the racks are networked within the data center using various topologies like optical and other high-bandwidth cabling. Further, data centers can be networked to each other with each data center acting as an independent “node” of its own. And this can be scaled up even further, especially as new technologies emerge to enable high-throughput of data.

Managing these multi-node use cases involves many advanced approaches to cross-node communication. However, a system in accordance with an embodiment of the present invention provides self-tuning that extends across nodes. For example, Application A is running a workload in a data center with five nodes present. Application B is also running in the same data center where a platform in accordance with an embodiment of the present invention has access to all five nodes. Application A is operating as optimally as possible and there is an additional 200 GB of RAM that is not being used and one of the RISC-V processors is mostly idle. Application B could run more optimally with additional RAM and some of the algorithms could benefit from the RISC-V processing. The platform effectively observes the opportunity to leverage the RAM and RISC-V available and optimizes Application B with no negative impact to Application A. The ability to use all available resources in a multiple node network is incredibly powerful.

A system which is accordance with an embodiment of the present invention is configured to provide a network with automated node provisioning. Specifically, as nodes are added to the network, two stages of provisioning occur. The first provisioning stage comprises a provisioning process whereby other nodes in the network and an agent managing the network become aware of a new node. The second provisioning stage comprises a provisioning process whereby a node comes online and self-tests. The system necessitates a boot cycle whereby all the available processors on a node go through a range of self-tests while also ensuring that the node itself is fully connected across the processors within the node. Depending upon the classes of processors on a node, this can be a complex process of:
1. Bringing each processor up (i.e., initializing and configuring each processor to make it operational and ready for use in the computing environment);
2. Running initial checks to confirm each processor has booted (i.e., verifying that each processor has successfully completed its boot-up sequence and is functioning correctly);
3. Deploying test applications to each processor;
4. Confirming expected outputs;
5. Confirming expected processor capabilities;
6. Confirming expected power consumption;
7. Validating each processor is properly networked to other processors on the node;
8. Running an end-to-end application across all processors on the node; and
9. Reporting back to the agent the outputs of the provisioning process.

These provisioning steps are unique to a system is accordance with an embodiment of the present invention, where other processor products typically only need to confirm that a single processor class is functioning properly upon booting the processor(s).

Another embodiment of the present invention comprises a PCB design that is configured to accept a System-on-Module (SoM) for a specific class of processors, preferably FPGAs. This PCB design accepts from one to 16 or more SoMs and enables each node to run workloads specific to FPGAs. Preferably, the PCB is configured such that multiple types of FPGAs can be connected, which further improves flexibility. Additionally, modularity of the design enables serviceability should a processor fail. Additionally, this approach enables future-proofing for this class of processors as new FPGAs come to market. The PCB is configured to provide on-board communication between the FPGAs, which provides additional flexibility in the software that can be deployed. Data is flowable from one FPGA to another or the data is routable back to another processor on the node.

Preferably, the PCB is configured to communicate with the node via optical interconnects. This allows for connecting the PCB directly to the node or routed through various methodologies that provide broader access to the processors. For example, 16 FPGAs or more can be disposed onto a single PCB while routing the connections to an agent that is managing multiple nodes. This agent can then leverage the FPGAs on the PCB in the most efficient way whereby multiple nodes can benefit from a single PCB with FPGAs connected to it.

Preferably, the software that powers the platform described herein (i.e., for operating a node, or multiple nodes working together) comprises several layers:
1. Orchestration across nodes.
2. Orchestration within nodes.
3. Data optimization.
4. Processor optimization.
5. User interfaces.
6. Additional capabilities worth noting.
7. Fault tolerance.

Preferably, a software platform which is accordance with an embodiment of the present invention is configured to enable GPU-based processors to run workloads on a system primarily managed via a CPU.

When training an artificial intelligence model, it would be beneficial to take advantage of many nodes to reduce the time to market for a given product and realize the additional benefits a platform in accordance with an embodiment of the present invention provides with regard to cross-node processor utilization. Going back to the agent/worker architecture, a platform in accordance with an embodiment of the present invention is configured to manage each “worker” in this context as groups of nodes. All resources within the network are available for any given workload.

Whether this is two nodes within a network, hundreds of nodes within a data center, or thousands of data centers with millions of nodes, a platform in accordance with an embodiment of the present invention is configured to manage scaling a workload to utilize the entire network as needed. This is managed through a range of strategies that include processor utilization monitoring, thread management, data aggregation, epoch sharding and more. These concepts fall under two broad categories: data parallelism and model parallelism.

Regarding data parallelism, when scaling distributed learning across many nodes, the application is configured to split the data being processed across nodes for processing. For example, a common batch size for a standard convolutional neural network is 256 images per batch. Due to the workload required, a system in accordance with the present invention splits the images across multiple nodes to leverage the appropriate processors for that stage of the process. This can be done synchronously or asynchronously, depending on the model's architecture. As each respective “worker” completes their processes, the outputs of their processes (such as gradients) are reported back to the “agent” where they are managed globally for all other nodes.

Regarding data parallelism, this leads to various strategies for ensuring that the outputs of each epoch of training are converging consistently. Splitting the model across nodes is often necessary not only for efficient use of processing, but also for memory needed to store the model. These models can exceed trillions of parameters which is far too large for a single node to store. Therefore, model parallelism becomes critical for larger workloads.

A system in accordance with an embodiment of the present invention enables several strategies:
1. Parameter Agent: the full model is managed in a single node whereby all other nodes report their gradients and the agent node updates the global model.
2. Gradient Aggregation: the central agent manages updating the global model as each node completes its respective work and then pushes the model out to the other nodes.
3. Hybrid Parallel: each node operates independently and the host agent updates the global model when each node is done, but the processes on other nodes can continue without pausing or waiting.
4. Epoch sharding: each node acts independently, updating its local model, and continuing with less frequent reporting back to the central agent node.
5. Distributed Optimizers: each node processes its batch of data, but the optimization stage is managed separately either on other nodes where the processors have been isolated for this stage or on the local node as resources permit.

Each of these strategies have benefits and drawbacks. A system in accordance with an embodiment of the present invention is configured to self-tune during training based on observed utilization across the network.

Preferably, a system in accordance with an embodiment of the present invention is configured to provide orchestration within nodes. In this context, a node is an individual block of processors. Each node must be carefully managed with each processor monitored to ensure a specific target (i.e., customer-chosen outcomes) are being accomplished. For example, if the application should be running with low power consumption as the target, the local node monitors the processor utilization and continuously optimizes for low-power processors.

Further, in a multi-node environment, each node may be configured with different processor classes or subclasses. For example, one node may have four FPGAs of the same type and another node may have four FPGAs where each is a different type. This example shows the importance of node-level orchestration that must be managed carefully.

Regarding data optimization, during any given workload the data being processed may be a candidate for optimization to improve performance—whether that performance target is speed, low power consumption, or precision. There are many strategies available for data optimization. A system in accordance with an embodiment of the present invention is configured to adapt the data in real time while a workload is running.

This is extremely beneficial. Common strategies for real-time data optimization include, but are not limited to:
1. Feature selection where various techniques can learn to drop or regularize features that do not affect the model as much over time.
2. Thresholding, which can be binary, and other methods to set various data points to 0 and 1 (or other values), which can reduce the computational overhead (quantization).
3. Dimensionality reduction, which can include dictionary learning to represent larger vector sets as much smaller values.
4. Noise filtering to reduce unnecessary data points.

These learnable capabilities can be applied more or less aggressively—or not at all—depending upon the customer's use cases. While these are conventional strategies, a system in accordance with an embodiment of the present invention is configured to leverage multiple processor classes to handle the data-optimization pipeline.

Regarding processor optimization, not all processors can be directly tuned. FPGAs are a unique case that have extraordinary flexibility, and a platform in accordance with an embodiment of the present invention is configured to leverage this class of processors aggressively. Preferably, the algorithms themselves are tuned in real-time to run on specific processor classes more efficiently.

A platform in accordance with an embodiment of the present invention focuses on optimizations for the FPGA. This is due to the fact that RISC-V and other ASIC processors can be too inflexible. GPUs as a processor class can be incredibly powerful, but newer algorithms are making this class less relevant, which puts more pressure on a given platform to be able to quickly be adapted to these innovations. FPGAs tend to enable the flexibility needed.

The platform preferably approaches processor optimization from two strategies: software updates and real-time learning. In the case of software updates, any new strategy, algorithm, or other optimization is applicable globally to nodes with the requisite processor types. Real-time optimization happens during a workload where the platform identifies a more optimal approach to running the workload. This can be with load balancing, algorithmic splitting, or other techniques.

To enable end users to effectively manage and use the platform disclosed herein, two primary tiers of interfaces can be provided: administration and data science.

Regarding the administration interface, regardless of the number of nodes available to a customer, they will need to configure their system to enable access and provision users. The interfaces enable a range of management for global features. The key features are:
1. Power-consumption constraints:
   a. Master limit on power consumption to the node level; and
   b. Default runtime options, such as defaulting to power-savings mode or high-performance mode.
2. Custom processor utilization settings that may be tailored to the customer.
3. Limits on how many nodes can be run on a given workload:
   a. Can be user-level access controlled; and
   b. Can be set to allow approvals for users who need larger workloads and may not have access to all nodes in the system.
4. Downtime options for when the system is not active.
   a. Options for what processes may run in the background
   b. Blockchain solutions
5. On-demand and dedicated access:
   a. Customers can choose to enable on-demand access for cases where a node or nodes are available for public use.
6. Payment options for purchasing compute:
   a. On-demand usage for short-term testing or small training needs
   b. Reserved instance purchasing for longer-term needs
   c. Other purchasing options such as additional services or support

Regarding the data science interface, the primary user of the system disclosed herein is a Data Scientist who intends to train a model. These users have the need to:
1. Choose a specific AI/ML domain (i.e., Computer Vision, Natural Language Processing, Timeseries, Unsupervised).
2. Ingest data from various sources (i.e., SSO access into internal/external system, Local data sources, Username/password/URL-based database access).
3. Perform data cleansing tasks (preferably the system comprises an internal rules-based-engine that enables sophisticated pipelines).
4. Pre-process data, e.g., train/test/split with stratification (including a Rules-based-engine).
5. Import an existing model, e.g., transferred learning, pruning, etc.
6. Evaluate model parameters in a sandbox environment before larger deployment. This typically involves tuning hyperparameters such as learning rate. The rules-based-engine, as mentioned above, can also come into play at this stage.
7. Run the training on a node or nodes (More rules-based-engine use cases are available, such as adjusting the learning rate, sparsity rules, and more).
8. Evaluate the model's performance.
9. Save/export the model file in various formats.

Preferably, a platform in accordance with an embodiment of the present invention is configured to take a novel approach to most of these stages. A typical workflow for a Data Scientist would be to start in a Python-based product such as Jupyter Notebooks or vanilla Python. In contrast, with the platform disclosed herein, the Data Scientist has access to a no-code solution that provides best-in-class tooling to ensure data pipelines and optimization of processors in any given node or network of nodes.

Other capabilities of the system disclosed herein include using a specialized data store solution that enables full utilization of the CPU core on a given node. This data store enables our platform to manage the model weights and biases during a training round in an efficient manner. More importantly, this data store solution enables memory to be shared across processors on a node, which gives the nodes of the system a significantly larger memory footprint.

Regarding processor fault tolerance, like any hardware-based solution, systems go down and parts break. To handle cases where a processor or other component may no longer function properly, the system disclosed herein preferably has the ability to isolate that component and continue to operate while parts are serviced.

Of course, some components are critical to basic operation and there is no way to avoid having to take down a node in those cases. In the case of an individual processor failing, the platform can effortlessly fail over and continue to operate. This is a unique capability at a node level that single-processor designs cannot manage.

Regarding model parallelism fault tolerance, in the case where a model is being trained across multiple nodes, various strategies such as epoch sharding can introduce situations where timing issues can cause issues with convergence of the gradients to the model.

Preferably, tools are provided for customers to select the data and model parallelism strategy that aligns with their risk for fault tolerance. Preferably, fully synchronous, asynchronous, or hybrid strategies are available with varying degrees of data and model integrity management.

Data and system security are mission critical. Due to the unique nature of a multi-class of processors on a single node as provided by a system in accordance with an embodiment of the present invention, data is passed across a node to various processors in various states, depending upon the model being used and the data source. Further, it is critical to ensure that only approved software is deployed to various processors. This is especially true since the platform can self-tune in the middle of a training round.

To address these risks, preferably there are three primary tiers of security:
1. Data encryption in flight and at rest on a node.
2. Processor-level software integrity checks to ensure only approved applications have been installed on any processor in a node.
3. Network-level monitoring to ensure bad actors have not accessed or modified any stage of the platform.

By way of example, a neural network designed for computer vision typically requires one or many convolutional layers whereby weights, biases, and other algorithmic methods are used to extract features from images. The present invention may use GPUs to preprocess images and convert the image data into tensors. The tensors may be passed to a RISC-V processor for inference using the weights and biases in the model. The outputs are then passed to an FPGA for loss function calculations and backpropagation to update the model's weights and biases.

In other use cases, all processors can be used for the entirety of the training where the workload is split across the processors. Using the computer vision example, the GPU may preprocess images into tensors and then complete the inference stage on 10% of the images for the purpose of load balancing the work on the RISC-V processor, further accelerating the workload. The FPGA can also manage a subset of the processing of images and inference, creating additional efficiencies.

This example can be extended to other neural network architectures and additional processor classes. Organoids present a useful case where processors are grown to handle a range of signal processing tasks. Sensor data may need to be preprocessed prior to the organoid processing the data and the output of the organoid may be passed to downstream processors. For example, FPGAs provide high degrees of control of sensor and signal processing which can be used to connect the outputs to an organoid. Temperature, light, and other sensor data can be captured and preprocessed by the FPGA in this example and passed to the organoid connected directly to the FPGA's outputs. The organoid's outputs are then passed to a RISC-V processor where inference is performed.

The processors disclosed herein can be configured to communicate with each other through a variety of interconnect technologies, such as buses, switches, and networks. These technologies allow the processors to exchange data, instructions, and control signals in order to coordinate their activities and work together to perform tasks.

One common method of communication that could be used is a system bus, which is a shared communication pathway that connects multiple processors and other components within a computer system. The processors can send data and instructions to each other over the system bus, allowing them to coordinate their activities and share resources.

In the multi-processor system disclosed herein, the processors may also communicate with each other through dedicated interconnect networks, such as Ethernet or InfiniBand. These networks provide high-speed, low-latency communication between processors, allowing them to exchange data and coordinate their activities more efficiently.

When two processors are communicating with each other, the algorithm they are executing is typically stored in the memory that is accessible to both processors. This could be in shared memory, where both processors can access the same memory locations, or in distributed memory where each processor has its own memory but can communicate and share data with the other processor.

In a shared memory system, the algorithm could be stored in a shared section of memory that both processors can read from and write to. This allows both processors to access and execute the algorithm simultaneously.

In a distributed memory system, each processor may have a copy of the algorithm stored in its own memory, but they can communicate with each other to share data and coordinate their activities in executing the algorithm.

In either case, the processors need to have a way to access and retrieve the algorithm instructions and data in order to execute it. This is typically done through communication protocols and mechanisms that allow the processors to exchange information and synchronize their actions.

The present invention effectively provides a self-tuning, hyperscaling, multi-class processor architecture for efficient high-performance compute workloads.

As such, an embodiment of the present invention provides a computing system comprising: a plurality of processors of at least three distinct classes, the processor classes selected from the group consisting of CPUs, GPUs, FPGAs, RISC-V processors, ASICs, TPUs, DPUs, VPUs, or Quantum chips; a shared random-access memory (RAM) accessible by each of the plurality of processors; and a management unit configured to dynamically assign workloads to one or more of the processors based on evaluation of workload requirements and processor capabilities, wherein said management unit further enforces a policy-driven runtime plan selected from speed, power efficiency, accuracy, or balanced performance, and is further configured to provision opportunistic cross-node resource lending without pausing donor workloads, thereby optimizing performance, and wherein the orchestration layer is implemented in a memory-safe manner to reduce risks of memory corruption.

Preferably, the management unit is configured to dynamically scale across multiple processor classes and leverage the most appropriate processor for each workload segment in accordance with runtime plan policies and real-time telemetry of power, time, and accuracy.

Preferably, the management unit is configured to monitor utilization of all processors and reallocates tasks to underutilized processors across nodes, subject to constraints that avoid quality-of-service impact on donor workloads.

Preferably, the management unit is configured to balance workloads across heterogeneous processor classes according to observed power consumption and performance characteristics, including external power-availability signals such as solar or grid variability.

Preferably, the system further comprises orchestration logic that provisions nodes using a two-stage provisioning cycle comprising: awareness by other nodes and an agent; and a boot cycle with multi-processor self-tests including expected power-draw validation, deployment of test workloads, inter-processor connectivity checks, and an end-to-end application validation before admission to the network.

Preferably, the management unit is also configured to detect idle processors across nodes and reassign workloads in real time, including fine-grained lending of specific processor classes such as RISC-V units or RAM to other nodes executing separate applications, with rollback if donor workloads are impacted.

Preferably, the management unit is also configured to implement cross-node scaling strategies and dynamically switches among parameter-agent, gradient aggregation, hybrid parallel, epoch-sharding, and distributed-optimizer strategies during a single training run, based on runtime plan objectives and observed utilization.

Preferably, the management unit is also configured to adapts workload allocation as new processor classes are added to the system without requiring downtime, provided that processor-level software integrity checks and provisioning validation have been completed.

Preferably, the system also includes monitoring logic configured to ensure all processor resources are efficiently utilized by comparing observed to expected power-consumption curves and initiating descheduling or failover upon anomaly.

Preferably, the management unit is also configured to optimize data preprocessing by mapping feature selection, thresholding, dimensionality reduction, or noise filtering tasks to the most suitable processor classes, and adjusting aggressiveness based on the selected runtime plan.

Another embodiment of the present invention provides a method for executing workloads on a heterogeneous compute system comprising at least three classes of processors. Preferably, the method comprises: receiving a workload; selecting or auto-selecting a runtime plan from speed, power efficiency, accuracy, or balanced performance; analyzing workload requirements; dynamically allocating portions of the workload to processors of different classes based on their capabilities; provisioning opportunistic cross-node resource lending under policy constraints; and continuously verifying that donor workloads are unaffected and rolling back allocation if negative impact is detected; and wherein the orchestration of workload execution is performed in a memory-safe manner to mitigate risks of memory corruption.

Preferably, the method further comprises reallocating workload segments across processor classes and nodes at mini-batch or training step boundaries to maintain model convergence, performing a two-stage provisioning cycle including: bringing up each processor, confirming successful boot, deploying test applications, verifying outputs, validating capabilities and expected power consumption, confirming inter-processor connectivity, executing an end-to-end workload, and reporting to an agent before workload execution, scaling the workload across a plurality of nodes interconnected in a network, including concurrent multi-application execution with fine-grained lending of memory and processor classes to other nodes under policy guardrails, and applying data optimization strategies including feature selection, thresholding, dimensionality reduction, and noise filtering, wherein each optimization task is mapped to a processor class and tuned according to runtime plan objectives.

Preferably, the workload execution includes distributing training data across nodes using data parallelism and dynamically switching among gradient aggregation, hybrid parallel, epoch-sharding, or distributed optimizers during training based on observed utilization and runtime plan.

Preferably, the method further comprises isolating failed processors by processor class and rerouting tasks to alternative processors of the same or fallback class in real time, while maintaining runtime plan objectives, and implementing a security protocol including data encryption in flight and at rest, processor-level integrity attestation before workload scheduling, and network-level monitoring to prevent tampering during self-tuning.

Preferably, the workload execution involves heterogeneous processor coordination such that GPUs preprocess input data, RISC-V processors perform inference, and FPGAs execute backpropagation, wherein inference and backpropagation may be distributed across different nodes interconnected by optical or PCIe fabric.

Preferably, the method further comprises receiving user input specifying a runtime optimization plan via administration or data science interfaces, applying node- or tenant-level power caps, and automatically overriding plans when external power availability changes, without pausing running workloads.

While specific embodiments of the invention have been shown and described, it is envisioned that those skilled in the art may devise various modifications without departing from the spirit and scope of the present invention.

1. A computing system comprising:
a plurality of processors of at least three distinct classes, the processor classes selected from the group consisting of CPUs, GPUs, FPGAs, RISC-V processors, ASICs, TPUs, DPUs, VPUs, or Quantum chips;
a shared random-access memory (RAM) accessible by each of the plurality of processors; and
a management unit configured to dynamically assign workloads to one or more of the processors based on evaluation of workload requirements and processor capabilities, and wherein the orchestration layer is implemented in a memory-safe manner to reduce risks of memory corruption.

2. The system of claim 1, wherein the management unit is configured to dynamically scale across multiple processor classes and leverage the most appropriate processor for each workload segment in accordance with runtime plan policies and real-time telemetry of power, time, and accuracy.

3. The system of claim 1, wherein the management unit monitors utilization of all processors and reallocates tasks to underutilized processors across nodes, subject to constraints that avoid quality-of-service impact on donor workloads.

4. The system of claim 1, wherein the management unit is configured to balance workloads across heterogeneous processor classes according to observed power consumption and performance characteristics, including external power-availability signals such as solar or grid variability.

5. The system of claim 1, further comprising orchestration logic that provisions nodes using a two-stage provisioning cycle comprising: awareness by other nodes and an agent; and a boot cycle with multi-processor self-tests including expected power-draw validation, deployment of test workloads, inter-processor connectivity checks, and an end-to-end application validation before admission to the network.

6. The system of claim 1, wherein the management unit is configured to detect idle processors across nodes and reassign workloads in real time, including fine-grained lending of specific processor classes such as RISC-V units or RAM to other nodes executing separate applications, with rollback if donor workloads are impacted.

7. The system of claim 1, wherein the management unit implements cross-node scaling strategies and dynamically switches among parameter-agent, gradient aggregation, hybrid parallel, epoch-sharding, and distributed-optimizer strategies during a single training run, based on runtime plan objectives and observed utilization.

8. The system of claim 1, wherein the management unit adapts workload allocation as new processor classes are added to the system without requiring downtime, provided that processor-level software integrity checks and provisioning validation have been completed.

9. The system of claim 1, wherein the system includes monitoring logic configured to ensure all processor resources are efficiently utilized by comparing observed to expected power-consumption curves and initiating descheduling or failover upon anomaly.

10. The system of claim 1, wherein the management unit is configured to optimize data preprocessing by mapping feature selection, thresholding, dimensionality reduction, or noise filtering tasks to the most suitable processor classes, and adjusting aggressiveness based on the selected runtime plan.

11. A method for executing workloads on a heterogeneous compute system comprising at least three classes of processors, the method comprising:
receiving a workload;
selecting or auto-selecting a runtime plan from speed, power efficiency, accuracy, or balanced performance;
analyzing workload requirements;
dynamically allocating portions of the workload to processors of different classes based on their capabilities;
provisioning opportunistic cross-node resource lending under policy constraints; and
continuously verifying that donor workloads are unaffected and rolling back allocation if negative impact is detected; and wherein the orchestration of workload execution is performed in a memory-safe manner to mitigate risks of memory corruption.

12. The method of claim 11, further comprising reallocating workload segments across processor classes and nodes at mini-batch or training step boundaries to maintain model convergence.

13. The method of claim 11, further comprising performing a two-stage provisioning cycle including: bringing up each processor, confirming successful boot, deploying test applications, verifying outputs, validating capabilities and expected power consumption, confirming inter-processor connectivity, executing an end-to-end workload, and reporting to an agent before workload execution.

14. The method of claim 11, further comprising scaling the workload across a plurality of nodes interconnected in a network, including concurrent multi-application execution with fine-grained lending of memory and processor classes to other nodes under policy guardrails.

15. The method of claim 11, further comprising applying data optimization strategies including feature selection, thresholding, dimensionality reduction, and noise filtering, wherein each optimization task is mapped to a processor class and tuned according to runtime plan objectives.

16. The method of claim 11, wherein workload execution includes distributing training data across nodes using data parallelism and dynamically switching among gradient aggregation, hybrid parallel, epoch-sharding, or distributed optimizers during training based on observed utilization and runtime plan.

17. The method of claim 11, further comprising isolating failed processors by processor class and rerouting tasks to alternative processors of the same or fallback class in real time, while maintaining runtime plan objectives.

18. The method of claim 11, further comprising implementing a security protocol including data encryption in flight and at rest, processor-level integrity attestation before workload scheduling, and network-level monitoring to prevent tampering during self-tuning.

19. The method of claim 11, wherein workload execution involves heterogeneous processor coordination such that GPUs preprocess input data, RISC-V processors perform inference, and FPGAs execute backpropagation, wherein inference and backpropagation may be distributed across different nodes interconnected by optical or PCIe fabric.

20. The method of claim 11, further comprising receiving user input specifying a runtime optimization plan via administration or data science interfaces, applying node- or tenant-level power caps, and automatically overriding plans when external power availability changes, without pausing running workloads.
